(19) United States
(12) Patent Application Publication
(10) Pub. No.: US 2026/0177202 A1
(43) Pub. Date: Jun. 25, 2026

(54) QUICK ASSEMBLY COMPONENT

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/431,362

(22) Filed: Dec. 23, 2025

(30) Foreign Application Priority Data
Dec. 25, 2024 (CN) 202423247485.2
Dec. 25, 2024 (CN) 202423254070.8

(51) Int. Cl. F16M 13/02; F16M 11/04

(52) U.S. Cl. CPC F16M 13/022; F16M 11/041

(57) ABSTRACT

A quick assembly component includes a quick-release base with a mounting chamber and an accommodation groove designed to accommodate an external structure. The accommodation groove features a stopping wall to secure the external structure. A hook-shaped member is positioned within the mounting chamber, with one end capable of extending into the accommodation groove and being arranged opposite the stopping wall, enabling it to cooperate with the stopping wall to lock the external structure. The quick assembly component also includes a locking mechanism connected to the hook-shaped member, which drives the hook-shaped member to move closer to or away from the stopping wall. Within a movement stroke, the hook-shaped member has a locking position to lock the external structure and an unlocking position to release the constraint on the external structure. This quick assembly component enables the rapid installation and removal of photographic accessories at target mounting positions.

### CROSS-REFERENCE TO RELATED APPLICATIONS

The present application for patent claims priority to and the benefit of pending Chinese Application No. 202423247485.2, filed Dec. 25, 2024 and Chinese Application No. 202423254070.8, filed Dec. 25, 2024 and, and hereby expressly incorporated by reference herein as if fully set forth below in its entirety and for all applicable purposes.

### TECHNICAL FIELD

The present disclosure pertains to the technical field of shooting auxiliary equipment, and more specifically to a quick assembly component.

### INTRODUCTION

With the advancement of economy and growth in the living standard, an increasing number of individuals have developed an interest in photography and videography, leading to the widespread use of various photographic accessories. During operation, users typically need to mount photographic accessories onto specific working positions, e.g., target mounting locations, such as attaching a monitor to the truss of a dolly cart or securing other equipment to specific mounting locations.

To avoid delays in shooting operations, it is essential to swiftly install photographic accessories onto working positions. Particularly for heavier photographic accessories, enhancing installation speed is crucial because it reduces the workload of operators. Therefore, there remains a need for a quick assembly component that facilitates the rapid installation of photographic accessories at working positions.

### BRIEF SUMMARY

Aspects of the present disclosure provide a quick assembly component, including:
A quick-release base with a mounting chamber and an accommodation groove configured to accommodate an external structure, the accommodation groove featuring a stopping wall to secure the external structure;
a hook-shaped member positioned within the mounting chamber, with one end configured to extend into the accommodation groove and being arranged opposite the stopping wall, enabling it to cooperate with the stopping wall to lock the external structure;
a locking mechanism connected to the hook-shaped member, which drives the hook-shaped member to move closer to or away from the stopping wall, the hook-shaped member having a locking position and an unlocking position within its movement stroke; at the locking position, the hook-shaped member cooperates with the stopping wall to lock the external structure; at the unlocking position, the hook-shaped member releases the constraint on the external structure, enabling it to be removed from between the hook-shaped member and the stopping wall.

According to the aforementioned quick assembly component, the stopping wall on the quick-release base cooperates with the hook-shaped member. Driven by the locking mechanism, they can clamp the external structure. When installing a photographic accessory onto an external structure at a working position, such as a quick-release plate at the working position, the photographic accessory can be connected and installed onto the quick-release base—that is, the photographic accessory is installed on the quick assembly component. Then, the quick assembly component is engaged with the quick-release plate at the working position, allowing the quick-release plate at the working position to enter between the stopping wall and the hook-shaped piece. Subsequently, the hook-shaped member is locked at the locking position via the locking mechanism, quickly achieving the connection between the quick-release plate and the quick assembly component, and thereby facilitating the rapid installation of the photographic accessory at the working position.

If the working position features a structure for connecting to the quick assembly component, the quick assembly component can be connected at the working position. The photographic accessory is connected to the quick-release plate. The quick installation of the quick-release plate onto the quick-release base allows for rapid installation of the photographic accessory at the working position.

### BRIEF DESCRIPTION OF THE DRAWINGS

FIG. 1 is a schematic diagram illustrating the usage state of a quick assembly component according to some aspects of the disclosure.

FIG. 2 is a schematic diagram illustrating the cooperation of the quick assembly component with a quick-release plate and a monitor according to some aspects of the disclosure.

FIG. 3 is a schematic diagram illustrating a base body of the quick assembly component according to some aspects of the disclosure.

FIG. 4 is a partial cross-sectional view illustrating the cooperation of a locking mechanism, a hook-shaped member, and a quick-release base in the quick assembly component according to some aspects of the disclosure.

FIG. 5 is a schematic diagram illustrating the connection of the hook-shaped member to a locking mechanism of the quick assembly component according to some aspects of the disclosure.

FIG. 6 is a schematic diagram illustrating the quick assembly component when an operation lever is at an operation lever locking position according to some aspects of the disclosure.

FIG. 7 is a schematic diagram illustrating the quick assembly component when the operation lever is at an operation lever unlocking position according to some aspects of the disclosure.

FIG. 8 is a schematic diagram illustrating an initial state when the quick-release plate is installed into a mounting space of the quick assembly component according to some aspects of the disclosure.

FIG. 9 is a schematic diagram illustrating a state after the quick-release plate has been installed into the mounting space of the quick assembly component according to some aspects of the disclosure.

FIG. 10 is a schematic diagram illustrating a mounting position of a cover plate of the quick assembly component according to some aspects of the disclosure.

FIG. 11 is a schematic diagram illustrating another perspective view of the quick-release base of the quick assembly component according to some aspects of the disclosure.

FIG. 12 is a schematic diagram illustrating an adjustment member of the quick assembly component according to some aspects of the disclosure.

FIG. 13 is a schematic diagram illustrating the cooperation of a claw locker and a connector in an embodiment of the quick assembly component according to some aspects of the disclosure.

List of feature names corresponding to reference numerals in the drawings:
100. Quick-release Plate; 200. Monitor;
300. Quick-release Base; 301. Base Body; 3011. Accommodation Groove; 3012. Stopping Wall; 3013. Mounting Chamber; 3014. Recess; 30141. Notch; 30142. Rounded Corner Structure; 302. Cover Plate; 303. Adjustment Member; 3031. Large-diameter Section; 3032. Small-diameter Section; 3033. Through Hole; 3034. Passage Hole;
400. Hook-shaped member; 401. Distal End; 402. Protrusion;
500. Mounting Space;
600. Locking Mechanism; 601. Operation Lever; 6011. Cam Structure; 60111. Flat Portion; 602. Connector; 6021. Intermediate Position Locking Slot; 6022. Round Rod Structure; 60221. Guiding Elongated Hole; 6023. Locking Position Slot; 603. Guide Pin; 604. Compression Spring; 606. Elastic member;
700. Joint Shaft; 800. Torsion Spring; 900. Claw Locker; 1100. Dolly Cart.

### DETAILED DESCRIPTION

Aspects of the present disclosure provide a quick assembly component. In the present disclosure, a hook-shaped member and a stopping wall of a quick assembly component cooperate. A locking mechanism is specifically provided for the hook-shaped member. This mechanism can lock the hook-shaped member at the locking position to secure the external structure between the stopping wall and the hook-shaped member. It can also unlock, allowing the hook-shaped member to reach the unlocking position, thereby releasing the constraint on the external structure and enabling it to be removed from between the hook-shaped member and the stopping wall. Thus, by driving the hook-shaped member via the locking mechanism to cooperate with the stopping wall, rapid installation and removal of the external structure onto/from the quick assembly component can be achieved, improving the convenience of installing and removing photographic accessories at target working positions.

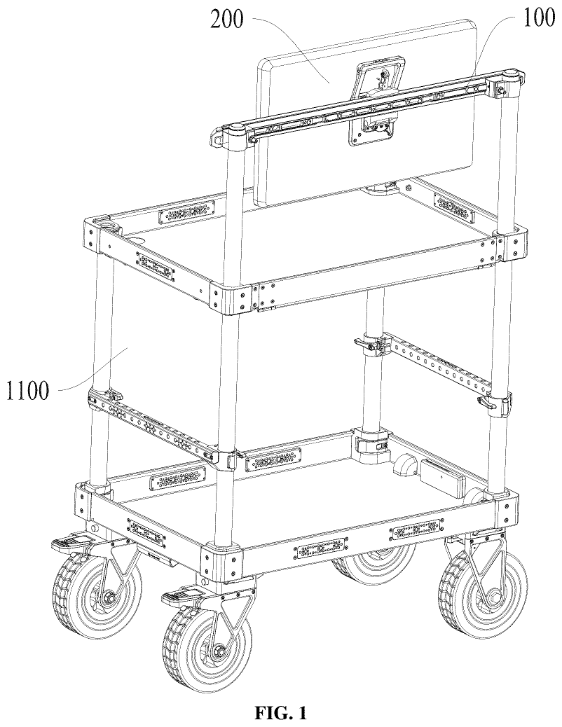

Referring to FIG. 1, the quick assembly component enables the installation of a photographic accessory onto an external structure. For example, the external structure can be the truss on a dolly cart 1100. The truss can be a crossbeam-style quick-release plate 100 installed on the dolly cart. In the operational state, the length of the quick-release plate 100 extends horizontally, its width vertically, and its thickness horizontally. In one example, the photographic accessory can be a monitor 200. The monitor 200 can be installed onto the quick-release plate 100 via the quick assembly component of the present disclosure.

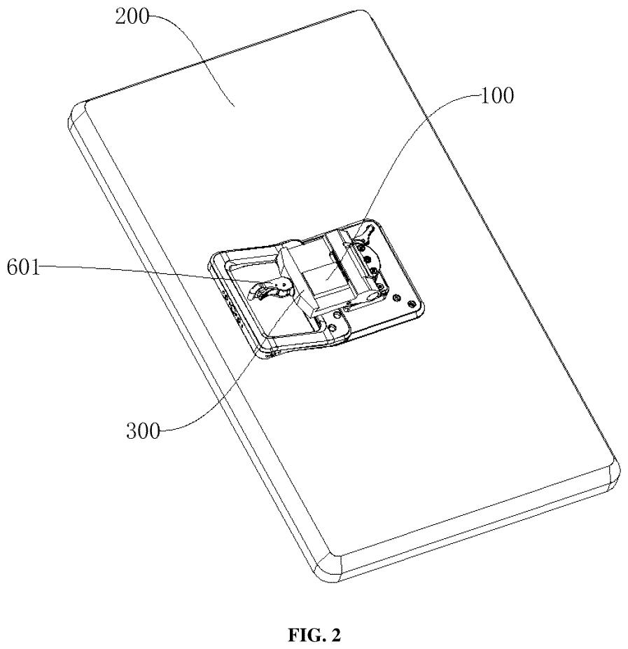

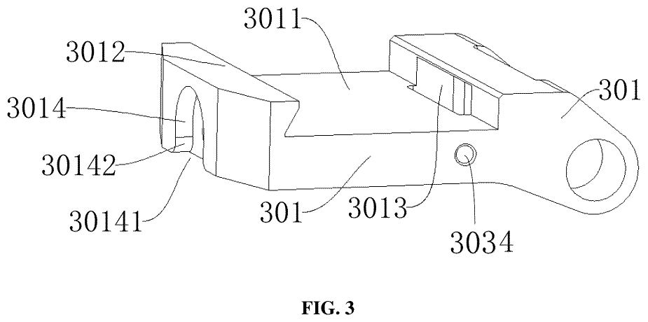

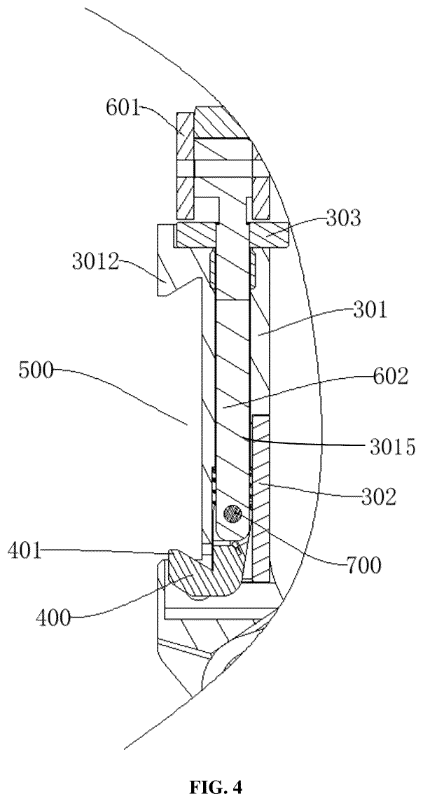

In some aspects, the quick assembly component includes a quick-release base 300. The quick-release base 300 features mounting structures for connecting and installing the photographic accessory (e.g., monitor 200). Referring to FIGS. 2 and 3, FIG. 2 illustrates a partial view of the quick-release plate 100. The quick-release base 300 has a base body 301. The base body 301 has an accommodation groove 3011 designed to accommodate the quick-release plate 100. The accommodation groove 3011 features a stopping wall 3012 to secure the quick-release plate 100. Referring to FIG. 4, the quick assembly component also includes a hook-shaped member 400 that cooperates with the stopping wall 3012.

Referring to FIG. 4, the stopping wall 3012 and the hook-shaped member 400 are arranged opposite each other. The hook-shaped member 400 and the stopping wall 3012 enclose a mounting space 500 that is used to accommodate the quick-release plate 100 between the hook-shaped member 400 and the stopping wall 3012. The shape of the mounting space 500 can conform to commonly used interface specifications in the photographic field, such as Manfrotto, Arca, Nato, etc. In some aspects, the stopping wall 3012 is an inclined wall that slopes towards the position of the hook-shaped member 400. As such, the stopping wall 3012 and the hook-shaped member 400 define a mounting space 500 with a trapezoidal cross-section that is smaller at the opening and larger inside, matching the trapezoidal cross-section of the quick-release plate 100.

In some aspects, the cross-sectional shape of the stopping wall can also be an inverted L-shape, and the specific shape and bending angle of the hook-shaped member match accordingly. This results in a cross-sectional shape of the mounting space being a T-shape (e.g., convex shape), which can also cooperate with the quick-release plate 100.

Referring to FIGS. 2, 4, and 5, to enable the hook-shaped member 400 to cooperate with the stopping wall 3012 to clamp the quick-release plate 100, the quick assembly component can include a locking mechanism 600. The locking mechanism 600 is connected to the hook-shaped member 400 and drives the hook-shaped member 400 to move towards the stopping wall 3012. The hook-shaped member 400 has a locking position and an unlocking position within its movement stroke. When the hook-shaped member 400 is driven by the locking mechanism 600 to the locking position, the hook-shaped member 400 cooperates with the stopping wall 3012 to lock the quick-release plate 100. When the hook-shaped member 400 is at the unlocking position, the quick-release plate 100 can be removed from between the hook-shaped member 400 and the stopping wall 3012. At the unlocking position, the minimum distance between the hook-shaped member 400 and the stopping wall 3012 is not less than the maximum width of the quick-release plate 100. Thus, when the quick assembly component needs to be separated from the quick-release plate 100, moving the quick assembly component directly allows the quick-release plate 100 to be removed from between the hook-shaped member 400 and the stopping wall 3012. To increase the locking force, in some examples, the surface of the hook-shaped member 400 that cooperates with the quick-release plate is provided with a protrusion 402.

Referring to FIGS. 4, 5, and 8, the hook-shaped member 400 is pivotally connected to the locking mechanism 600 via a joint shaft 700. The locking mechanism 600 includes an operation lever 601 and a connector 602. The connector 602 is rod-shaped and is mounted on the quick-release base 300 in a reciprocally movable manner. The hook-shaped member 400 is pivotally connected with the connector 602 via the joint shaft 700. In some aspects, the hook-shaped member 400 and the operation lever 601 are connected to opposite ends of the connector 602. An elastic driving member can be arranged between the hook-shaped member 400 and the quick-release base 300, configured to drive the hook-shaped member 400 to rotate towards the locking position. In one example, the elastic driving member can be a torsion spring 800 sleeved on the joint shaft 700. One end of the torsion spring 800 abuts against and cooperates with the hook-shaped member 400, and the other end abuts against and cooperates with the quick-release base 300. In some aspects, the other end of the torsion spring 800 does not cooperate with the quick-release base 300 but instead cooperate with the connector 602; alternatively, one end can simultaneously cooperate with both the connector 602 and the quick-release base 300, while the other end cooperates with the hook-shaped member. In some aspects, the elastic driving member can be a coil spring arranged between the joint shaft 700 and the hook-shaped member 400, or a tension spring connected between the hook-shaped member 400 and the connector 602. In some examples, the hook-shaped member 400 can be fixedly connected to the locking mechanism 600.

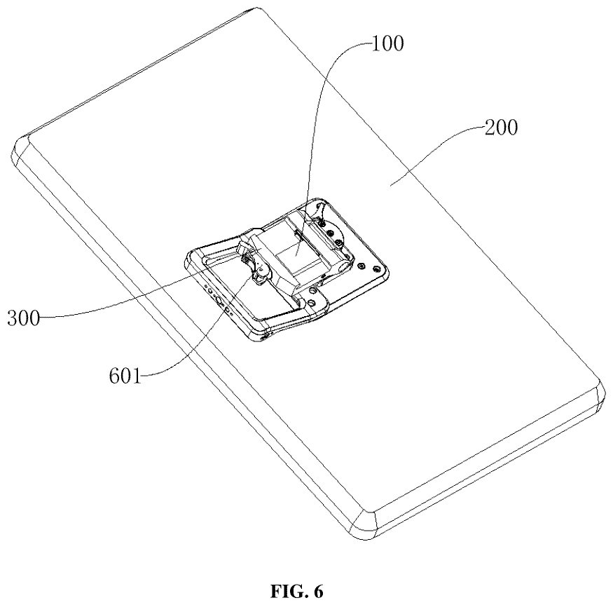

The operation lever 601 is pivotally connected to the connector 602 and features a cam structure 6011. During operation, the operation lever 601 abuts against and cooperates with the quick-release base 300 via the cam structure 6011. The operation lever 601 can be set at an operation lever locking position corresponding to the locking position of the hook-shaped member 400 within its rotation stroke. In this state, referring to FIG. 6, the operation lever 601 is approximately at the 180-degree position.

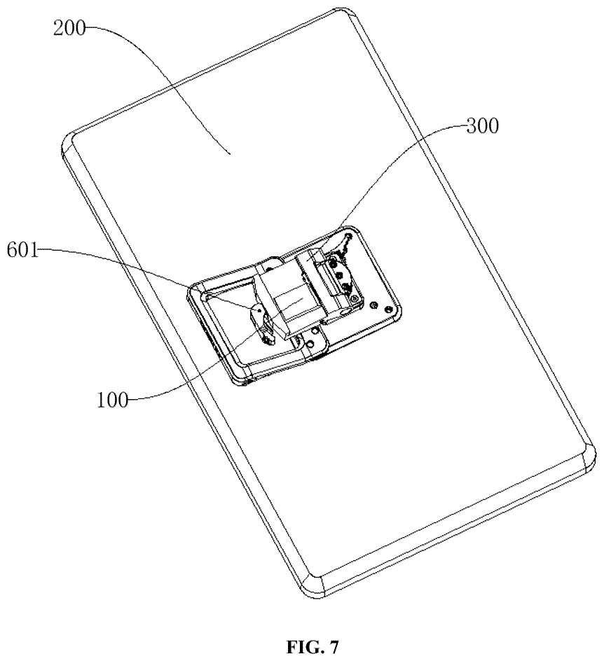

The operation lever 601 can be set at an operation lever unlocking position corresponding to the unlocking position of the hook-shaped member 400 within its rotation stroke. For this state, referring to FIG. 7, the operation lever 601 is approximately at the 0-degree position. When the small-diameter portion of the cam structure 6011 abuts against and cooperates with the quick-release base 300, the operation lever 601 is at the operation lever unlocking position, and the hook-shaped member 400 is at the unlocking position. When the large-diameter portion of the cam structure 6011 abuts against and cooperates with the quick-release base 300, the operation lever 601 is at the operation lever locking position, and the hook-shaped member 400 is at the locking position.

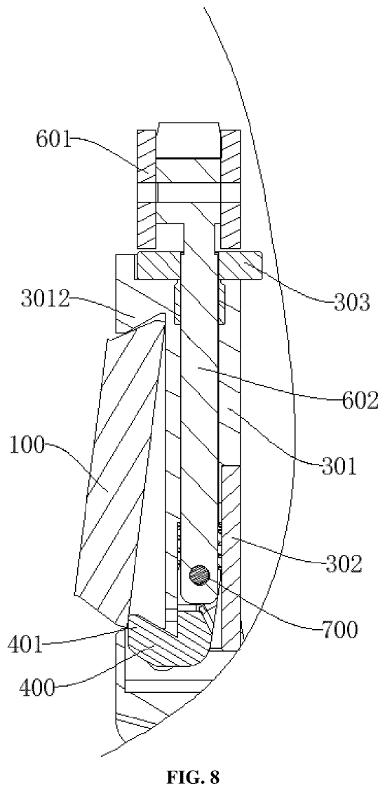

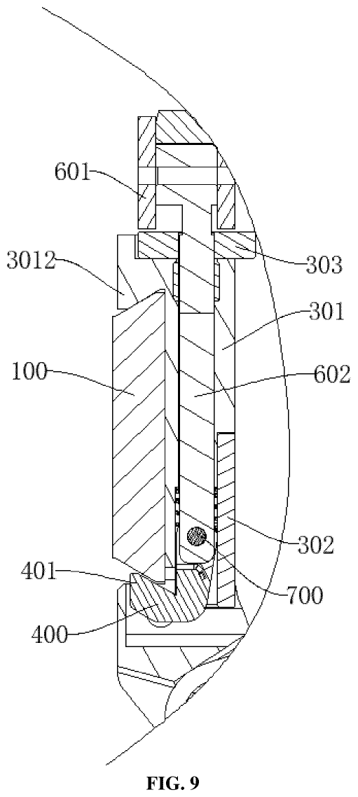

During use, the operation lever 601 can be rotated to a position between the unlocking and locking positions of the operation lever. In some aspects, this position can be approximately at a 90-degree angle. In some aspects, the hook-shaped member 400, driven by the locking mechanism, reaches a position between the locking and unlocking positions. Referring to FIG. 2, at this time, the distance between the distal end 401 of the hook-shaped member 400 and the stopping wall 3012 is less than the width of the quick-release plate 100. When installing the quick-release plate 100, as shown in FIG. 8, one side of the quick-release plate 100 can first be engaged to a position that cooperates with the stopping wall 3012. At this point, the other side of the quick-release plate 100 will press against the distal end 401 of the hook-shaped member 400. Since the hook-shaped member 400 is pivotally connected to the connector 602, when the quick-release plate 100 is pressed into the mounting space 500, it forces the hook-shaped member 400 to rotate out of the way of the quick-release plate 100. After the quick-release plate 100 is installed in place, driven by the torsion spring 800, the hook-shaped member 400 rotates back towards the quick-release plate 100, as illustrated in FIG. 9.

After resetting, the hook-shaped member 400 cooperates with the stopping wall 3012 to constrain the quick-release plate 100 within the mounting space 500. The mutual cooperation between the side bevel of the quick-release plate 100 and the inner surface of the hook-shaped member 400 prevents the quick-release plate 100 from easily disengaging from the mounting space 500. Furthermore, because the hook-shaped member 400 does not firmly lock the quick-release plate 100, the monitor 200 can slide along the quick-release plate 100 together with the quick assembly component. This allows for adjustment of the mounting position of the monitor 200 while preventing it from easily detaching from the quick-release plate 100.

In some aspects, when installing the monitor 200 onto the quick-release plate 100, the operation lever 601 can first be rotated to an intermediate position between the unlocking and locking positions of the operation lever, such as the aforementioned approximately 90-degree position. Then, the assembly including the monitor 200 and the quick assembly component is mounted onto the quick-release plate 100. Once the quick-release plate 100 enters the mounting space 500, there is no longer a need to hold up the monitor 200, freeing the operator's hands. The monitor 200 is moved along the quick-release plate 100 to a suitable position. Subsequently, the operation lever 601 can be rotated to the locking position of the operation lever to lock the quick-release plate 100 in place. This achieves rapid installation of the monitor 200 at the target mounting location while reducing the time the operator needs to hold up the monitor 200, thereby lowering the workload. This is particularly suitable for installing heavy photographic accessories at target mounting positions.

The intermediate position refers to a position between the locking and unlocking positions of the operation lever. Correspondingly, the hook-shaped member is at a position between the unlocking and locking positions. It is not necessarily the exact midpoint. In some examples, the intermediate position can include other non-90-degree positions (e.g., a 60-degree position, a 100-degree position, etc.) between the unlocking and locking positions of the operation lever, as long as they meet the aforementioned operational requirements.

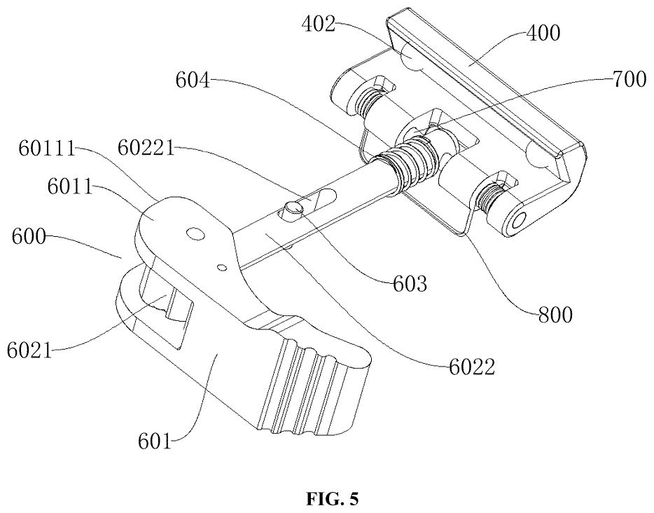

In some aspects, referring to FIGS. 5, 10, and 13, a locking structure is provided between the operation lever 601 and the connector 602. The locking structure includes a claw locker 900 pivotally mounted on the operation lever. An elastic member 606 is provided between the claw locker 900 and the operation lever 601. The elastic member 606 can include a compression spring press-fitted between the operation lever 601 and the claw locker 900, a torsion spring arranged between the claw locker 900 and the operation lever 601, or a tension spring connected between the claw locker 900 and the operation lever 601. The elastic member 606 drives the claw locker 900 to abut tightly against the connector 602. The locking structure can include an intermediate position locking slot 6021 formed on the connector 602, enabling the cooperation between the claw locker 900 and the connector 602 to form a ratchet mechanism (e.g., ratchet and pawl structure). This restricts the operation lever 601 to rotate only from the unlocking position of the operation lever towards the locking position of the operation lever. When the operation lever 601 needs to move from the locking position of the operation lever towards the unlocking position of the operation lever, pressing the end of the claw locker 900 away from the connector 602 disengages the claw locker 900 from the intermediate position locking slot 6021.

To further improve the stability of the operation lever 601 when locked in the intermediate position, the cam surface of the cam structure 6011 can have an anti-rotation cooperation portion 60111. The anti-rotation cooperation portion 60111 has a section that can be a substantially flat structure. When the operation lever 601 is rotated to the intermediate position and the claw locker 900 cooperates with the intermediate position locking slot, the operation lever 601 cooperates with the adjustment member 303 of the quick-release base 300 via the anti-rotation cooperation portion, further enhancing the stability of the operation lever 601 maintained at the intermediate position and preventing the operation lever 601 from rotating. In other examples, the anti-rotation cooperation portion 60111 can have raised dots on the cam surface. Correspondingly, grooves cooperating with the dots are provided on the portion of the quick-release base that cooperates with the operation lever. When the operation lever is rotated to the intermediate position, the dots are engaged into the grooves.

In some aspects, to ensure the operation lever 601 remains stably at the locking position of the operation lever as well, a locking position slot 6023 can set on the connector 602 at the position corresponding to the locking position of the operation lever. Thus, when the operation lever 601 is at the locking position of the operation lever, it can be locked for reliable position retention, preventing unintended unlocking.

In some aspects, the locking structure can be of other types, such as a pin-type locking structure. For example, a pin hole can be provided on the operation lever 601, and locking holes can be provided on the connector 602. The positions of the locking holes correspond to the target positions where the operation lever 601 is to be locked. When the operation lever 601 is rotated to the target position, the pin hole aligns with a locking hole. Inserting a locking pin into the pin hole and the locking hole locks the operation lever 601 at that intermediate position. The locking mechanism does not necessarily be a structure where the operation lever cooperates with a connector. For example, it can be a structure where a lock nut cooperates with a screw rod. The screw rod serves as the connector, and the screw rod connects to the hook-shaped member at one end and cooperates with the lock nut at the other end. When the end surface of the lock nut abuts tightly against the quick-release base 300, the hook-shaped member 400 is locked in the locking position.

Referring to FIGS. 3, 10, and 11, the base body 301 has a mounting chamber 3013 for accommodating the hook-shaped member 400. The mounting chamber 3013 penetrates through the base body 301. The distal end 401 of the hook-shaped member 400 extends out through an opening at one end of the mounting chamber 3013 to cooperate with the stopping wall 3012. The quick-release base 300 has a cover plate 302 installed at the other opening end of the mounting chamber 3013. After the hook-shaped member 400 is installed within the mounting chamber 3013, the cover plate 302 is installed in place. Following installation of the cover plate 302, the torsion spring 800 abuts against and cooperates with the cover plate 302. This structure allows the concealment of the hook-shaped member 400, the torsion spring 800, and the connection structure between the hook-shaped member 400 and the connector 602 within the quick-release base 300, which is not only aesthetically pleasing but also protects the hook-shaped member 400, its connection structure with the connector 602, and the torsion spring 800. To facilitate assembly, a passage hole 3034 penetrating the chamber wall is provided on the wall of the mounting chamber 3013. During assembly, the hook-shaped member 400 and the connector 602 can be aligned within the mounting chamber 3013, and the joint shaft 700 can be inserted through the passage hole 3034 to pivotally connect the hook-shaped member 400 and the connector 602 together. In some examples, the mounting chamber need not be provided on the base body, and the hook-shaped member can be exposed outside the base body.

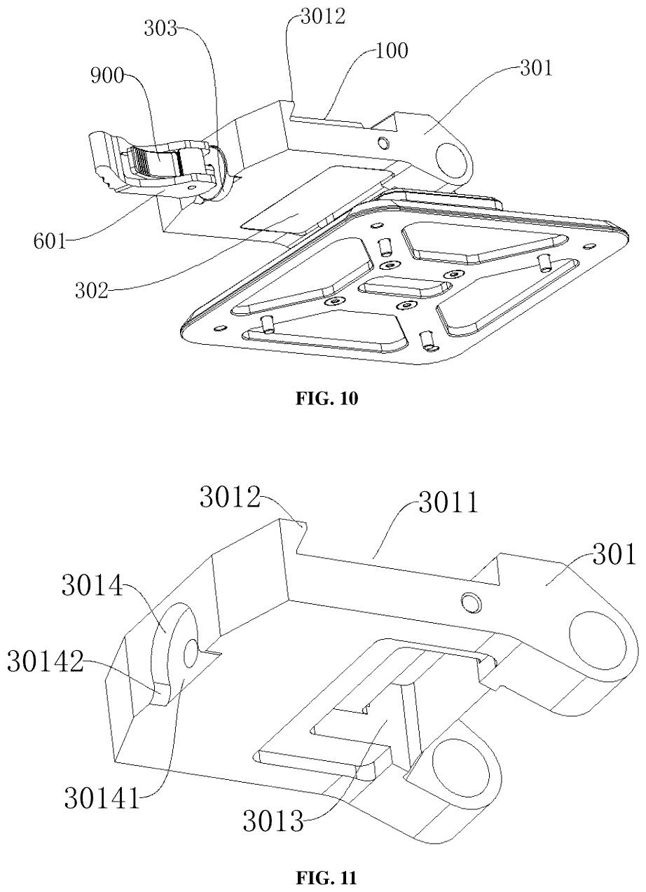

In some aspects, referring to FIG. 10, besides the base body 301 and the cover plate 302, the quick-release base 300 can include an adjustment member 303. Referring to FIG. 11, the accommodation groove 3011, the stopping wall 3012, and the mounting chamber 3013 are located on the base body 301. A passage communicating with the mounting chamber 3013 is provided on the base body 301. The connector 602 is installed within this passage for a reciprocally movable installation of the locking mechanism on the quick-release base 300. In some aspects, the hook-shaped member can also be installed on the base body to move reciprocally in a straight line along a provided track. In some aspects, the connector can be fixedly connected to the hook-shaped member and does not need to directly assemble and cooperate with the base body.

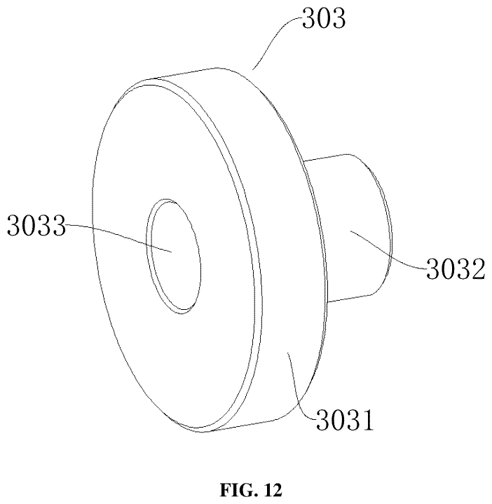

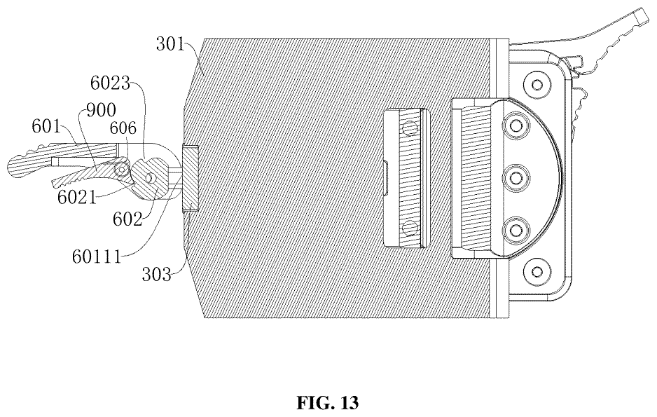

Referring to FIG. 12, the adjustment member 303 has a large-diameter section 3031 and a small-diameter section 3032. The outer side of the small-diameter section 3032 is formed with threads. The port of the passage for installing the connector 602 has a recess 3014 (see FIG. 11). The end of the passage connected to the recess 3014 can have internal threads, forming a threaded hole for the adjustment member 303 to be screwed into. Defining the direction in which the hook-shaped member 400 is driven to move by the connector 602 as the adjustment direction, the adjustment member 303 is installed on the base body 301 so that it can be screwed in and out along the adjustment direction. The adjustment member 303 has a through hole 3033 in its center for the connector 602 to pass through. The through hole 3033 communicates with the passage. The operation lever 601 abuts against and cooperates with the adjustment member 303. Thus, by adjusting the amount the adjustment member 303 is screwed into the threaded hole, the operational slackness (e.g., mechanical play) when the operation lever 601 is actuated can be changed, i.e., the adjustment slackness of the connector 602 can be adjusted. In some aspects, after the adjustment member 303 is screwed outward and adjusted, when operating the operation lever 601 and adjusting the position of the connector 602 to drive the hook-shaped member 400 to lock the quick-release plate 100, the feel becomes tighter, meaning greater operating force is required. Conversely, the feel becomes looser, requiring less operating force, satisfying the operational preferences of different users.

Referring to FIG. 5, at least one of the operation lever 601 and the connector 602 is movably installed on the quick-release base 300. The connector 602 and the operation lever 601 are rotationally connected. One of the operation lever 601 and the adjustment member 303 contacts and cooperates with the other via a curved surface structure. The curved surface structure extends in a direction away from the stopping wall 3012. When the operation lever 601 actuates relative to the adjustment member 303, it can drive the hook-shaped member 400, via the connector 602, to move closer to or away from the stopping wall 3012, thereby locking or releasing the external structure.

In some aspects, the port of the threaded hole on the base body 301, into which the adjustment member 303 is screwed, features a recess 3014. This recess 3014 is designed to accommodate the large-diameter section 3031 of the adjustment member. The wall of the recess 3014 can have a notch 30141, allowing a portion of the large-diameter section 3031 of the adjustment member 303 to be exposed. The outer peripheral surface of the large-diameter section 3031 is equipped with a force application structure prepared for the operator. In some aspects, the outer peripheral surface of the large-diameter section 3031 of the adjustment member 303 features a concave-convex structure (not depicted in the drawings), which serves as the force application structure. The operator can rotate the adjustment member 303 by friction contact between their fingertip and the large-diameter section 3031, thereby adjusting the depth to which the adjustment member 303 is screwed into the base body 301. To prevent finger injury, the opening edge of the notch 30141 is designed as a rounded corner structure 30142. In one example, as shown in FIG. 11, the orientation of the notch 30141 is opposite to the opening direction of the mounting space 500, preventing accidental contact with the adjustment member 303 during the installation of the quick-release plate 100. In some examples, the wall of the recess may not have a notch. In some aspects, the end surface of the adjustment member 303 can feature a structure compatible with a tool, enabling adjustment by rotating the adjustment member with the tool. In some examples, the recess 3014 may be absent from the quick-release base 300. In some aspects, the large-diameter section 3031 of the adjustment member 303 is fully exposed, facilitating easier adjustment. However, this may compromise the overall structural simplicity of the quick assembly component and increase the risk of accidental contact with the adjustment member 303, leading to unintended rotation.

In some aspects, as shown in FIG. 5, the part of the connector 602 that cooperates with and installs onto the quick-release base 300 is a round rod structure 6022. The hook-shaped member 400 is pivotally connected with this round rod structure 6022. A guiding elongated hole 60221 is provided on the round rod structure, with a corresponding guide pin 603 arranged within it. To install the guide pin 603, a guide pin installation hole (not shown in the drawings), which connects with the passage for installing the connector 602, is provided on the quick-release base 300. During assembly, the connector 602 is installed within the passage on the quick-release base 300, aligning the guiding elongated hole 60221 with the guide pin installation hole. Subsequently, the guide pin 603 is inserted into the guide pin installation hole, extending into the guiding elongated hole 60221. Then, a pipe plug is installed at the port of the guide pin installation hole to prevent the guide pin 603 from dislodging. In some aspects, a guiding elongated hole that communicates with the exterior and the passage accommodating the connector can be formed on the quick-release base. The guide pin 603 is fixedly installed on the round rod structure. In some aspects, during assembly, the connector can first be installed into the passage, aligning the hole on the round rod structure of the connector for installing the guide pin with the guiding elongated hole. Then, the guide pin 603 is fixedly installed on the connector through the guiding elongated hole.

In some aspects, a compression spring 604 is sleeved on the round rod structure 6022. One end of the compression spring 604 abuts against and cooperates with the quick-release base 300, while the other end abuts against and cooperates with the joint shaft 700. Thus, when the connector 602 moves toward the locking position along with the hook-shaped member 400, the compression spring 604 is compressed and stores energy. When the operation lever 601 reaches the operation lever locking position, the reaction force exerted by the compression spring 604 on the connector helps maintain the operation lever 601 stably at the operation lever locking position. Moreover, after the locking mechanism is unlocked, the compression spring 604 can drive the locking mechanism, along with the hook-shaped member 400, to move to the unlocking position. In some examples, the compression spring 604 can be connected to both the quick-release base 300 and the joint shaft 700.

In some aspects, the photographic accessory can be other equipment, such as a camera or camcorder. The quick-release plate can be connected to the photographic accessory, while the quick-release base is connected to a structural member at the target mounting position, such as a tripod. This enables the rapid installation and removal of the photographic accessory on the tripod.

The foregoing uses specific examples to elucidate the present disclosure, which are merely intended to aid in understanding the present disclosure and not to limit its scope. For technical personnel in the relevant technical field, based on the concept of the present disclosure, several simple deductions, modifications, or substitutions can also be made.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A quick assembly component, comprising:
a quick-release base is provided with a mounting chamber and an accommodation groove for accommodating an external structure, wherein the accommodation groove is provided with a stopping wall for stopping the external structure;
a hook-shaped member arranged in the mounting chamber, wherein one end of the hook-shaped member is extendable into the accommodation groove and is disposed opposite to the stopping wall, and is configured to cooperate with the stopping wall to lock the external structure in the accommodation groove; and
a locking mechanism connected to the hook-shaped member, wherein the locking mechanism is configured to drive the hook-shaped member to move in a first direction toward the stopping wall and in a second direction away from the stopping wall;
wherein the hook-shaped member is configured with a locking position and an unlocking position along a movement stroke; and
wherein at the locking position, the hook-shaped member cooperates with the stopping wall to lock the external structure, and at the unlocking position, the hook-shaped member releases constraint on the external structure, enabling the external structure to be removable from between the hook-shaped member and the stopping wall.

2. The quick assembly component according to claim 1, wherein the hook-shaped member is further provided with an intermediate position along a movement stroke at which the hook-shaped member is driven by the locking mechanism; and
wherein in response to the hook-shaped member being at the intermediate position, a distance between the hook-shaped member and the stopping wall corresponds to a size of the external structure so as to constrain but not locking the external structure.

3. The quick assembly component according to claim 2, further comprising a locking structure configured to lock a position of the locking mechanism on the quick-release base, so as to maintain the hook-shaped member at the intermediate position.

4. The quick assembly component according to claim 3, wherein the locking mechanism comprises an operation lever and a connector;
wherein the hook-shaped member is connected to the connector;
wherein the operation lever is hinged on the connector and is provided with a cam structure configured to abut against the quick-release base;
wherein the locking structure comprises a claw locker hinged on the operation lever;
wherein an elastic member is arranged between the claw locker and the operation lever to drive the claw locker to abut tightly against the connector;
wherein the locking structure further comprises an intermediate position locking slot formed on the connector; and
wherein the claw locker and the intermediate position locking slot cooperate to form a ratcheting mechanism.

5. The quick assembly component according to claim 4, wherein a locking position slot is further formed on the connector for cooperating with the claw locker to lock a position of the operation lever in response to the hook-shaped member being at the locking position.

6. The quick assembly component according to claim 2, wherein the hook-shaped member is hinged to the locking mechanism;
wherein an elastic driving member is arranged between at least one of the locking mechanism and the quick-release base, and the elastic driving member is configured to drive the hook-shaped member to reset toward the stopping wall; and
wherein the locking mechanism is movably installed on the quick-release base in a reciprocating manner.

7. The quick assembly component according to claim 4, wherein the hook-shaped member is connected to an end of the connector.

8. The quick assembly component according to claim 4, wherein the quick-release base comprises a base body and an adjustment member;
wherein the operation lever abuts against the adjustment member, and the adjustment member is threadedly screwed into the base body; and
wherein the connector passes through the adjustment member, enabling an adjustment slackness of the connector to be adjustable by changing an amount by which the adjustment member is screwed into the base body.

9. The quick assembly component according to claim 8, wherein at least one of the operation lever and the connector is movably installed on the quick-release base;
wherein the connector and the operation lever are rotatably connected;
wherein operation lever and the adjustment member contact and cooperate with each other via a curved surface structure; and
wherein the curved surface structure extends in a direction away from the stopping wall, enabling the hook-shaped member to be drivable via the connector to move toward or away from the stopping wall in response to the operation lever acting relative to the adjustment member, thereby locking or releasing the external structure.

10. The quick assembly component according to claim 9, wherein the adjustment member comprises a large-diameter section and a small-diameter section;
wherein the small-diameter section is provided with an external thread connected to the base body;
wherein a threaded hole of the base body for screwing the adjustment member is provided with a recess at an opening thereof;
wherein the recess is configured to accommodate the large-diameter section of the adjustment member;
wherein a groove wall of the recess has a notch;
wherein a part of the large-diameter section of the adjustment member is exposed through the notch; and
wherein an outer peripheral surface of the large-diameter section is provided with a force application structure for an operator to apply force.

11. The quick assembly component according to claim 10, wherein an opening edge of the notch comprises a rounded corner structure.

12. The quick assembly component according to claim 10, wherein an orientation of the notch is opposite to an orientation of an opening of the accommodation groove.

13. The quick assembly component according to claim 9, wherein the connector is rod-shaped and is installed through a passage formed in the base body;
wherein a center of the adjustment member defines a through hole that communicates with the passage; and
wherein the connector extends out of the through hole.

14. The quick assembly component according to claim 13, wherein the hook-shaped member is connected to one end of the connector, and the operation lever is hinged to another end of the connector;
wherein the operation lever is provided with a cam structure configured to abut against the adjustment member; and
wherein a cam surface of the cam structure constitutes the curved surface structure.

15. The quick assembly component according to claim 14, wherein the cam surface comprises an anti-rotation cooperation portion; and
wherein in response to the claw locker cooperating with the intermediate position locking slot, the anti-rotation cooperation portion of the operation lever cooperates with the adjustment member to prevent rotation of the operation lever.

16. The quick assembly component according to claim 4, wherein at least a portion of the connector installed in cooperation with the quick-release base comprises a round rod structure, and the round rod structure is installed through a passage formed in the quick-release base;
wherein the round rod structure is provided with a guiding elongated hole;
wherein the quick-release base has a guide pin mounting hole communicating with the passage; and
wherein a guide pin installed in the guide pin mounting hole extends into the guiding elongated hole.

17. The quick assembly component according to claim 4, wherein at least a portion of the connector installed in cooperation with the quick-release base comprises a round rod structure, and the round rod structure is installed through a passage formed in the quick-release base; and
wherein, the quick-release base comprises a guiding elongated hole communicating with an exterior and the passage, and a guide pin installed on the round rod structure extends into the guiding elongated hole.

18. The quick assembly component according to claim 16, wherein a compression spring is sleeved on the round rod structure; and
wherein one end of the compression spring abuts against or is connected to the quick-release base, and another end abuts against or is connected to a joint shaft for hinging the hook-shaped member on the round rod structure.

19. The quick assembly component according to claim 1, wherein the accommodation groove is provided with a side wall opposite to the stopping wall; and
wherein an opening is formed on the side wall for the hook-shaped member to extend out.
